(19) United States
(12) Patent Application Publication
(10) Pub. No.: US 2003/0039457 A1
(43) Pub. Date: Feb. 27, 2003

(54) Broken fiber detecting conduit for optical fibers; and methods

(76) Inventor: Marlon E. Holmquist, Gibbon, MN (US)

Correspondence Address: MERCHANT & GOULD PC, P.O. BOX 2903, MINNEAPOLIS, MN, 55402-0903, US

(21) Appl. No.: 09/940,848

(22) Filed: Aug. 27, 2001

(51) Int. Cl. G02B 6/44; G02B 6/26

(52) U.S. Cl. 385/107; 385/12

(57) ABSTRACT

A structure and method for detecting a broken optical fiber includes providing a fiber optic cable holding a first optical fiber and a jacket, and breaking the first optical fiber to trigger an alarm. In preferred embodiments, an outer conduit is provided around the fiber optic cable, and the conduit carries a second optical fiber. The second optical fiber creates a circuit path with a control device, and upon breakage of the first optical fiber, the second optical fiber is burnt through to break the circuit path. This break in the circuit path is detected by the control device, which stops the transmission of signals across the optical fiber cable and/or triggers an alarm.

### TECHNICAL FIELD

This disclosure relates to fiber optic cables and methods. In particular, this disclosure relates to structure and methods for detecting a broken optical fiber.

### BACKGROUND

Fiber optic cables are utilized to communicate by sending light waves over the fiber optics. A signal is sent in, circuitry converts the signal to voltage/current to drive a light source (LED or laser), and then the light is delivered to the fiber. The signal travels down the fiber to a receiver where it is converted back from an optical signal to an electrical signal. In some uses, the fiber can be carrying high powers, on the order of 1-2 watts of energy or more. Periodically, these fibers may break. Upon breakage, the energy escapes and can lead to a fire or other damage, and/or bodily injury to personnel. Improvements in fiber optic cables are desirable.

### SUMMARY

In one aspect, the disclosure is directed to a fiber optic cable including a protective, outer covering that is constructed and arranged to provide an alarm if an optical fiber breaks.

In particular, in one embodiment, a fiber optic cable includes a first extension of optical fiber core and cladding; a buffer covering the fiber core and cladding; a strength member covering the buffer; a jacket covering the strength member; a conduit covering the jacket; and a second extension of low temperature optical fiber along the conduit exterior surface.

In one embodiment, an optical fiber system includes an optical fiber cable, as described herein, and a control device. The control device is in optical contact with opposite ends of the second optical fiber to form a circuit path. The control device includes an alarm that is triggered in response to a break in the circuit path.

In another aspect, a method for protecting conventional optical fiber is provided. The method includes a step of inserting the conventional optical cable assembly into a protective conduit. The conduit has a second optical fiber, wherein the second optical fiber has opposite ends. A circuit path is formed with each end of the second optical fiber, and an alarm is provided that is triggered upon breakage of the circuit path.

In another aspect, a method for detecting a broken optical fiber is provided. When the primary optical fiber breaks, the outer optical fiber melts and triggers an alarm.

### BRIEF DESCRIPTION OF THE DRAWINGS

FIG. 1 is a schematic, perspective view of one embodiment of an optical fiber system, constructed according to principles of this disclosure;

FIG. 2 is a schematic, top plan view of one embodiment of a fiber optic cable and detection device, constructed according to principles of this disclosure;

FIG. 3 is a schematic, fragmented, perspective view of the fiber optic cable depicted in FIG. 2, constructed according to principles of this disclosure;

FIG. 4 is a schematic, cross-sectional view of another embodiment of a fiber optic cable and detection device, constructed according to principles of this disclosure; and

FIG. 5 is a schematic, fragmented, perspective view of another embodiment of a fiber optic cable, analogous to the view shown in FIG. 3, constructed according to principles of this disclosure.

### DETAILED DESCRIPTION

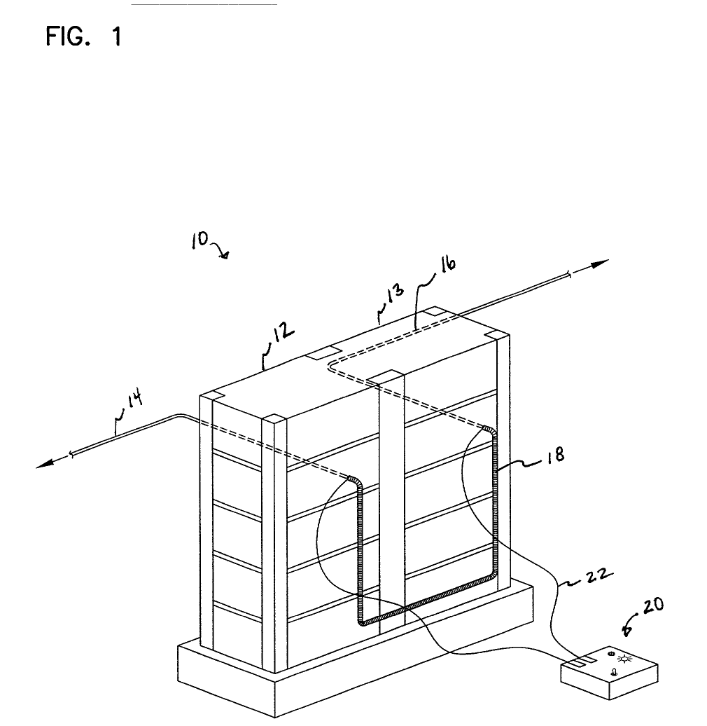

FIG. 1 depicts, schematically, one example embodiment of a system 10 constructed according to principles of this disclosure. In FIG. 1, the system 10 includes equipment 12, such as a distributing frame 13, outside plant (OSP) fiber optic cables 14, equipment patch cords 16, and cross-connect patch cords 18. Also shown schematically in FIG. 1 is a control device 20 and an optical fiber 22 in optical contact with the control device 20. If the patch cord 18 were to break, the control device 20 will detect this breakage, and shut down the system 10, and preferably, provide an alarm. This is described further below.

It should be understood that the system 10 illustrated in FIG. 1 is merely one example embodiment of a myriad of contemplated embodiments.

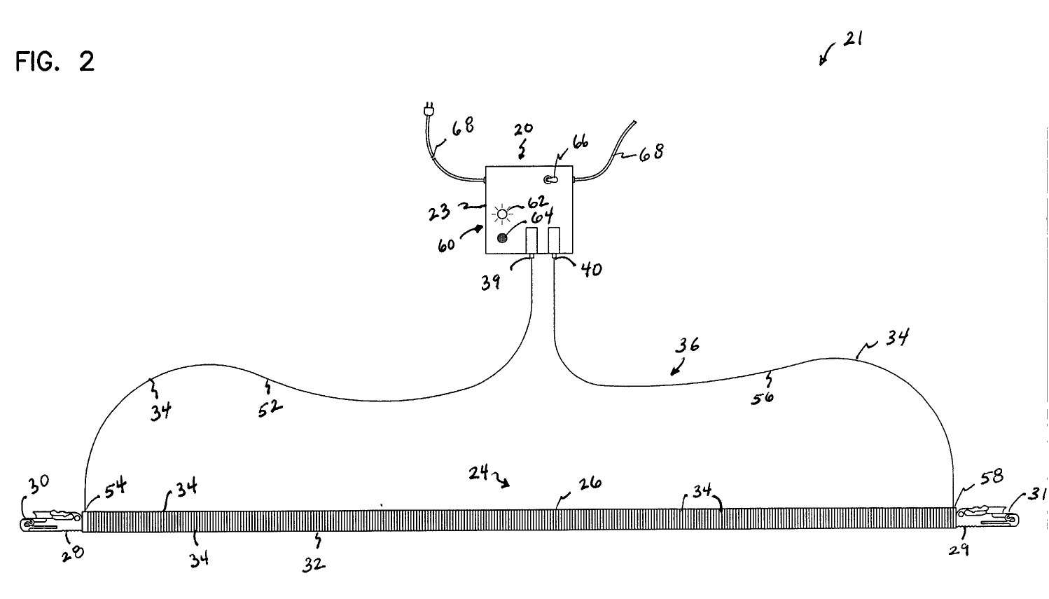

Attention is now directed to FIG. 2. In FIG. 2, a system 21 is shown including the control device 20 optically connected to a fiber optic cable assembly 24. The fiber optic cable assembly 24 may be the OSP cables 14, equipment patch cord 16, cross-connect patch cords 18, or many other types of uses for fiber optic cables. The particular fiber optic cable assembly 24 illustrated is a patch cord 26. The patch cord 26 has first and second opposite ends 28, 29, each having a connector 30, 31 terminating each end. The connector 30 may be one of many types of connectors, including, for example, the connector described in U.S. Pat. No. 5,883,995, assigned to ADC Telecommunications, Inc., Minnetonka, Minn., the assignee of this patent application. U.S. Pat. No. 5,883,995 is incorporated herein by reference.

In FIG. 2, the exterior of the patch cord 26 is visible. The exterior of the patch cord 26 includes a cover or conduit 32 and an extension of optical fiber 34 along the conduit 32. In preferred embodiments, the optical fiber 34 is wrapped around the exterior surface of the conduit 32. Indeed, in preferred embodiments, the optical fiber 34 is spirally wrapped around the exterior surface of the conduit 32. The reason for this is explained further below.

With this background in mind, a general overview of operation of the system 21 can be appreciated. The fiber optical cable assembly 24 includes, at its core, an optical fiber, which may be carrying a high amount of power, such as 1-2 watts of energy or more. If this fiber core breaks, the energy will melt the outer conduit 32 and break the optical fiber 34. A break in the optical fiber 34 will cause an interruption of the circuit path 36 created by opposite ends 39, 40 of the optical fiber 34 with the control device 20. The break in the circuit path 36 will cause a detection system 23 in the control device 20 to detect this break. The control device 20 will preferably provide an alarm, in the form of video, audio, or both. The control device 20 will also shut down the appropriate system that includes the fiber optic cable assembly 24.

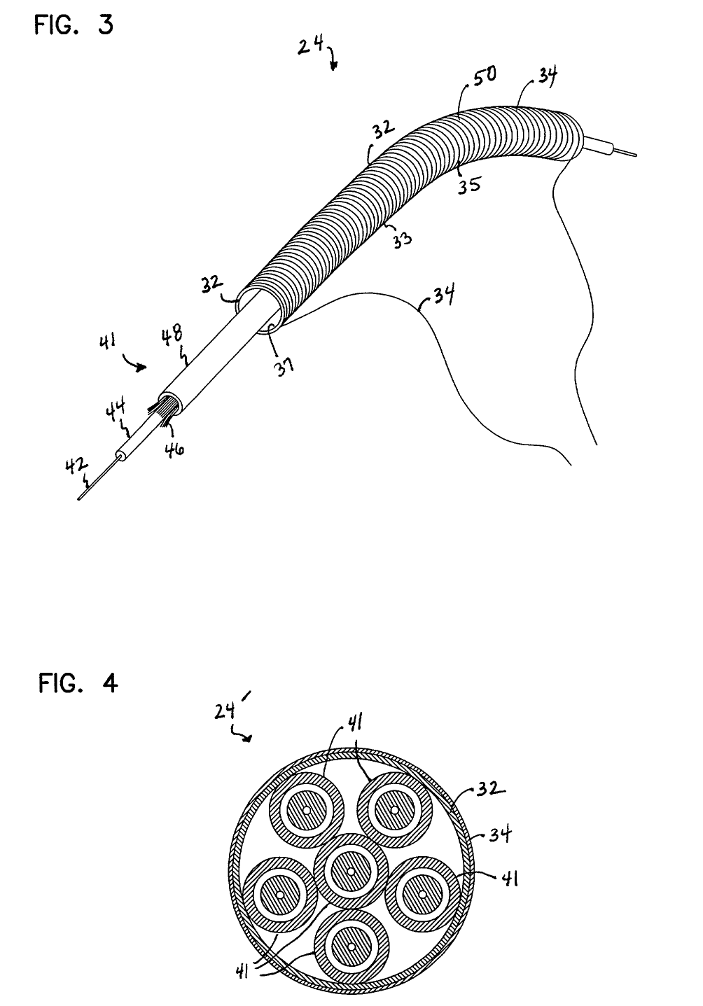

Attention is now directed to FIG. 3. The fiber optic cable assembly 24 is shown in fragmented, perspective view. As can be seen in FIG. 3, the fiber optic cable assembly 24 includes fiber optic cable 41. The fiber optic cable 41 preferably includes a central fiber 42 (including a core and a cladding); a buffer 44; a strength member 46; and a jacket 48. The fiber 42 is what translates the signals across the cable 24. The fiber 42 may be covered with a coating. Covering the fiber 42 is buffer 44. The buffer 44 protects the fiber core and cladding 42. Covering and surrounding the buffer 44 is strength member 46. The strength member 46 adds mechanical strength to the cable 24. In particular, tensile stresses are applied to the cable 24 both during installation and after. The strength member 46 protects the fiber 42 against such stresses. Typical materials utilized for strength member 46 include aramid yam, steel, epoxy, and other suitable materials.

The fiber optic cable 41 also further include a jacket 48 covering and surrounding the strength member 46. The jacket 48 provides protection against damage caused by crushing, abrasions, and other physical damage, as well as elements such as ozone, alkali, acids, and other chemical damage. Jacket 48 may be made of a variety of materials, depending upon the resistance required and the cost.

Covering and surrounding the jacket 48 is the conduit 32. As can be seen in FIG. 3, the conduit 32 generally is a tubular wall 33 defining a hollow interior 37 and an exterior surface 50. The fiber optic cable 41 is received by and passes through the interior 37. Preferably, the conduit 32 comprises a material with a melting point sufficiently low to permit energy from a broken fiber 42 to melt through the conduit 32. For example, the conduit 32 may be constructed from materials having a melting point no greater than 400° F. Usable materials for the conduit 32 include: PVC or HDPE.

The conduit 32 may be constructed from a material that is bendable in order to permit flexibility in the cable 24. By the term “bendable”, it is meant that the material may be altered from a straight line configuration under a force no greater than 2 pounds. In other embodiments, the conduit 34 may be semi-rigid. By “semi-rigid”, it is meant that the material is not easily bent, such that it takes a force of at least 2 pounds to bend the material.

Extending along the exterior surface 50 of the conduit 32 is the optical fiber 34. Of course, this optical fiber 34 is separate and independent from the central, signal communicating optical fiber 42. The optical fiber 34 forms a second extension 35 of optical fiber in the cable 24. The optical fiber 34 preferably comprises a low temperature, plastic, optical fiber. By “low temperature”, it is meant that it has a melting point no greater than 600° F., preferably no greater than 500° F. With melting points on this order, the signals provided across the fiber 34 will be interrupted in the case of the fiber 42 breaking, releasing energy and melting through fiber 34. As explained earlier, by breaking the signal in the fiber 34, the circuit path 36 will be broken and cause an alarm to activate.

In preferred embodiments, the fiber 34 extends along the exterior surface 50 of the conduit 32 in a manner that offers a large amount of coverage of the surface area of the exterior surface 50. In this way, it will not matter at what point the breakage in the fiber 42 occurs; there will be a fiber 34 located adjacent to the breakage. In the particular preferred embodiment illustrated, the fiber 34 is wrapped around the exterior surface 50 of the conduit 34. In alternate embodiments, the fiber 34 may be secured to and extend along the interior surface of the conduit 32. The fiber 34 may also be oriented axially along the surface 50 of the conduit 34.

Preferably, the fiber 34 is spirally wrapped around the conduit 32. As can be seen in FIG. 2, the fiber 34 includes a lead or free portion 52 extending between the end 39 and the end 54 of the cable assembly 24. This free portion 52 lacks physical contact with the conduit 32; that is, it is the portion that extends between the conduit 32 and the control device 20. Similarly, the fiber 34 includes a lead or free portion 56 that extends between end 40 and end 58 of the cable assembly 24. The end 58 is an opposite end of the cable as the end 54. While the free portions 52, 56 are shown in the particular illustrated embodiment as extending from opposite ends 54, 58 of the cable assembly 24, in other embodiments, the fiber 34 can be doubled back against itself such that one or both of the free portions 52, 56 extends from any portion of the conduit 32, including from a common end 54 or 58.

In some embodiments, the fiber 34 may be merely spirally wound around the conduit 32 without any other types of security therebetween. In other embodiments, the fiber 34 may be adhered to the conduit 32 with a suitable adhesive. In some embodiments, the fiber 34 may be protected with an outer layer of material.

Preferably, the control device 20 includes an alarm 60. The alarm 60 may include a variety of mechanisms to alert those operating the system that there has been a break in the fiber 42. In the particular embodiment illustrated, the alarm 60 includes a blinking light 62 and an audio siren 64. Upon breaking of the circuit path 36, the detection system 23 will preferably cause the alarm 60 to be activated. Preferably, the detection system 23 will also cause the cable 24 to shut down (that is, signals will no longer be sent through the cable 24). Other features of the control device 20 include a power switch 66 and appropriate electrical cabling 68. The electrical cabling 68 can, in some embodiments, lead to a control office that includes a warning system for monitoring.

The conduit 32 is usable to hold at least one fiber optic cable 41 and may hold a plurality of such cables 41. Attention is directed to FIG. 4. FIG. 4 illustrates a schematic, cross-sectional view of a fiber optic cable assembly 24′ including the conduit 32 with the optical fiber 34 held thereon, and enclosing a plurality of cables 41. In the embodiment shown in FIG. 4, there are six cables 41 that are held by the conduit 32. If any one of the cables 41 includes a fiber 22 that is broken, the release of energy will cause the conduit 32 to melt and to break the outer fiber 34.

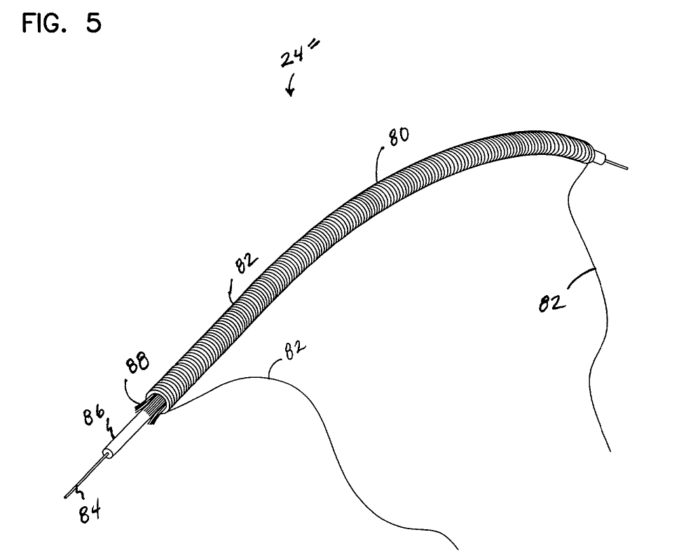

In FIG. 5, an alternative embodiment is illustrated. In the embodiment shown in FIG. 5, the conduit 34 is eliminated all together; instead, a specially adapted jacket-conduit 80 is utilized. The jacket-conduit 80 is analogous to the jacket 48 described above, but in this embodiment, the jacket-conduit 80 includes an optical fiber 82 extending therealong. The jacket-conduit 80, in this embodiment, is also analogous to the conduit 34 of the previous embodiment. As can be seen in FIG. 5, in particular, the optical fiber 82 is spirally wrapped around the jacket-conduit 80. The fiber optic cable assembly 24″ shown in FIG. 5 otherwise includes all of the parts described above, including fiber core and cladding 84, buffer 86, and strength member 88. If the optical fiber core 84 breaks, the energy will melt the jacket-conduit 80 and cause the fiber 82 to break. The breaking of this fiber 82 will break the circuit path 36 and cause an alarm to be activated.

Fiber optic cable assembly 24 may be protected utilizing the principles discussed herein as described below. Optical cable 41 including a first optical fiber and a jacket covering the optical fiber is provided. The optical cable may include the fiber core and cladding 42, buffer 44 and strength member 46, as described herein. The jacket may include the type of jacket 48 described herein. The jacket 48 is covered with conduit 32, which includes a second optical fiber, such as optical fiber 34. The second optical fiber 34 has opposite ends 39, 40. Circuit path 36 is formed with each end 39, 40 of the optical fiber 34. Detection system 23 is provided that is triggered upon breakage of the circuit path 36.

A method for detecting a broken optical fiber may be conducted utilizing the structures and principles described herein. In general, the optical fiber 42 with the jacket 48 is provided. The optical fiber 42 is broken to trigger the alarm 60 in the detection system 23. The alarm 60 may be either blinking light 62, audio siren 64, or both. As explained above, the step of breaking the optical fiber 42 includes breaking the fiber 42 to emit energy that burns through the second optical fiber 34, which breaks the circuit path 36 and triggers alarm 60. This also preferably includes burning through the outer conduit 32, in order to burn through the optical fiber 34.

What is claimed is:

1. A fiber optic cable assembly comprising:
(a) at least one fiber optic cable including:
(i) a first extension of optical fiber core and cladding;
(ii) a buffer covering said first extension of optical fiber core and cladding;
(iii) a strength member covering said buffer;
(b) a conduit covering said fiber optic cable; said conduit defining an exterior surface; and
(c) a second extension of optical fiber along said conduit exterior surface.

2. A fiber optic cable assembly according to claim 1 wherein:
(a) said second extension of optical fiber forms a spiral wrap around said exterior surface of said conduit.

3. A fiber optic cable assembly according to claim 2 wherein:
(a) said second extension of optical fiber comprises a plastic material.

4. A fiber optic cable assembly according to claim 3 wherein:
(a) said plastic material has a melting point no greater than 600° F.

5. A fiber optic cable assembly according to claim 2 further including:
(a) an adhesive securing said second extension of optical fiber to said exterior surface of said conduit.

6. A fiber optic cable assembly according to claim 1 wherein:
(a) said conduit comprises a material bendable from a force no greater than 2 pounds.

7. A fiber optic cable assembly according to claim 1 wherein:
(a) said conduit comprises a material bendable from a force at least 2 pounds.

8. A fiber optic cable assembly according to claim 1 further including:
(a) first and second optical connectors at opposite ends of said fiber optic cable.

9. A fiber optic cable assembly according to claim 1 further including:
(a) a plurality of fiber optic cables held within an interior of said conduit.

10. A fiber optic cable assembly according to claim 1 wherein:
(a) said fiber optic cable includes a jacket covering the strength member;
(i) said conduit covering said jacket.

11. A fiber optic cable assembly according to claim 1 further including:
(a) a detector to detect a break in said second extension of optical fiber.

12. An optical fiber system comprising:
(a) a cable assembly including:
(i) a fiber optic cable including a first extension of optical fiber;
(ii) a conduit covering said fiber optic cable; said conduit defining an exterior surface; and
(iii) a second extension of optical fiber along said conduit exterior surface; said second extension having first and second opposite ends; and
(b) a control device; said control device being in optical contact with said first end of said second extension of optical fiber and said second end of said second extension of optical fiber to form a circuit path;
(i) said control device including an alarm that is triggered in response to a break in said circuit path.

13. A system according to claim 12 wherein:
(a) said second extension of optical fiber forms a spiral wrap around said exterior surface of said conduit.

14. A system according to claim 12 wherein:
(a) said second extension of optical fiber comprises a plastic material.

15. A system according to claim 14 wherein:
(a) said plastic material has a melting point no greater than 600° F.

16. A system according to claim 12 wherein:
(a) said second extension of optical fiber is breakable to result in breaking of said circuit path and triggering of said alarm.

17. A system according to claim 16 wherein:
(a) said alarm includes a visual alarm.

18. A system according to claim 16 wherein:
(a) said alarm includes an audio alarm.

19. A system according to claim 12 wherein:
(a) said cable assembly includes first and second optical connectors at opposite ends of said cable assembly.

20. A method for protecting an optical fiber; the method comprising:
(a) providing a fiber optic cable including a first optical fiber; and
(b) covering the fiber optic cable with a conduit having a second optical fiber;
the second optical fiber having opposite ends.

21. A method according to claim 20 further including:
(a) forming a circuit path with each end of the second optical fiber; and
(b) providing a detection system that is triggered upon breakage of the circuit path.

22. A method according to claim 20 wherein:
(a) said step of covering the fiber optic cable with a conduit includes covering the fiber optic cable with a conduit having a second optical fiber spirally wrapped around an exterior of the conduit.

23. A method according to claim 20 wherein:
(a) said step of providing a fiber optic cable includes: providing an optical fiber core and cladding; a buffer covering the optical fiber core and cladding; a strength member covering the buffer; and a jacket covering the strength member.

24. A method according to claim 20 wherein:
(a) said step of covering the fiber optic cable with a conduit having a second optical fiber includes: covering the fiber optic cable with a conduit having a plastic optical fiber with a melting point less than 400° F.

25. A method according to claim 20 wherein:
(a) said step of covering the fiber optic cable with a conduit includes covering a plurality of fiber optic cables with a conduit having a second optical fiber.

26. A method for detecting a broken optical fiber; the method comprising:
(a) providing an optical cable including a first optical fiber and a jacket covering the first optical fiber; and
(b) sensing a continuity of a signal pathway through the first optical fiber, wherein a breakage in the first optical fiber is sensed and an alarm is triggered.

27. A method according to claim 26 further including:
(a) breaking the first optical fiber to trigger an alarm.

28. A method according to claim 27 wherein:
(a) said step of breaking includes breaking the first optical fiber to burn through a second optical fiber and trigger an alarm.

29. A method according to claim 27 wherein:
(a) said step of breaking includes breaking the first optical fiber to burn through an outer conduit and a second optical fiber and trigger an alarm.

30. A method according to claim 29 wherein:
(a) said step of breaking the first optical fiber to burn through an outer conduit and a second optical fiber includes breaking the first optical fiber to burn through the outer conduit and a second optical fiber wrapped around an exterior of the outer conduit and trigger an alarm.

31. A method according to claim 29 further including:
(a) before said step of breaking, creating a circuit path by connecting opposite ends of the second optical fiber into a control device; the control device including the alarm triggerable by a break in the circuit path.

32. A cover for protecting a fiber optic cable; the cover comprising:
(a) a conduit including a tubular wall having a hollow interior and an exterior surface;
(i) said hollow interior being sized to receive a fiber optic cable therein; and
(b) an extension of optical fiber wrapped around said conduit exterior surface.

33. A cover according to claim 32 wherein:
(a) said extension of optical fiber forms a spiral wrap around said exterior surface of said conduit.

34. A cover according to claim 32 wherein:
(a) said extension of optical fiber comprises a plastic material;
(i) said plastic material having a melting point no greater than 600° F.
